(19) United States
(12) Patent Application Publication
(10) Pub. No.: US 2008/0046849 A1
(43) Pub. Date: Feb. 21, 2008

(54) METHOD FOR CHANGING PHYSICAL LAYOUT DATA USING VIRTUAL LAYER

(76) Inventor: Seung-Ho Choi, Seoul (KR)

Correspondence Address: SHERR & NOURSE, PLLC, 620 HERNDON PARKWAY, SUITE 200, HERNDON, VA, 20170, US

(21) Appl. No.: 11/839,206

(22) Filed: Aug. 15, 2007

(30) Foreign Application Priority Data
Aug. 16, 2006 (KR) 10-2006-0077193

(51) Int. Cl. G06F 17/50

(52) U.S. Cl. 716/6; 716/7

(57) ABSTRACT

A method for changing physical layout data using a virtual layer is provided. The method codes a target design and synthesizes a logic for it. It may generate a virtual layer, places logic blocks at positions and route them for connection to execution elements. Wiring resistance or capacitance values may be extracted. A timing check may be performed and crosstalk may be analyzed for physical implementation. Interconnections and wirings of transistors may be checked for correspondence with the circuit. Wiring spaces and gate lengths may be checked for compliance with preset specifications. A mask based on the virtual layer may be produced. Thus, the virtual layer is generated by software prior to physical verification when physical layout data is changed, which allows use of LVS/DRC suitable for a fab in which actual processes are performed, achieving reliable physical verification.

The present application claims priority under 35 U.S.C. 119 to Korean Patent Application No. 10-2006-0077193, filed on Aug. 16, 2006, which is hereby incorporated by reference in its entirety.

### BACKGROUND

To efficiently use fab resources and to increase productivity, physical layout data (for example, physical library or GDSII data) from a specific fab may be made available to a different fab to allow both fabs to produce the same products. This not only increases productivity but also increases the efficiency of utilization of existing fab resources.

A layer map file is used when physical layout data is transferred. If new layers are required in a fab into which the physical layout data is transferred, the layers must be generated. For example, an artisan library introduced in fab A for 0.18 nm processes is transferred to an existing fab B for 0.18nm processes, so that products can be manufactured in both fabs, thereby increasing the efficiency of use of the fab resources. If fab B uses two layers including an N active layer and a P active layer, and fab A uses one common active layer, new layers (e.g. an N active layer and a P active layer) must be generated if there are N and P implant layers surrounding a common active layer.

A method for transferring physical layout data uses a Manufacturing Electronic Beam Exposure System (MEBES) to generate such new layers (e.g. N and P active layers) when creating mask data and allows physical layout data to be transferred from fab A to fab B.

However, a method may not generate new layers suitable for fab B since, in the design flow, a Logic Versus Schematic/Design Rule Check (LVS/DRC) is performed before mask data is created. Therefore, even though the fab B is used, physical verification may be performed using the LVS/DRC for fab A, thereby causing heterogeneity between the LVS/DRCs for the two fabs. Thus, when physical layout data is verified, the reliability of the verification may not be ensured.

### SUMMARY

Embodiments relate to a method for changing physical layout data using a virtual layer, wherein a virtual layer is generated by software prior to physical verification when physical layout data is changed, which makes it possible to use a Logic Versus Schematic/Design Rule Check (LVS/DRC) suitable for a fab (which is short for a fabrication or a fabrication facility) in which actual processes are to be carried out, thereby achieving reliable physical verification.

Embodiments relate to a method for changing physical layout data using a virtual layer, which may maximize reliability of verification of a physical layout. Embodiments relate to a method for changing physical layout data using a virtual layer, wherein a virtual layer is generated by software prior to physical verification when physical layout data is changed, which makes it possible to use a Logic Versus Schematic/Design Rule Check (LVS/DRC) suitable for a fab in which actual processes are to be carried out, thereby achieving reliable physical verification.

Embodiments relate to a method for changing physical layout data using a virtual layer which may include at least one of the following steps: Coding a target design and synthesizing logic for the coded target design. Generating a virtual layer. Placing logic blocks at corresponding positions and routing the logic blocks for connection to execution elements. Extracting wiring resistance or capacitance values and performing a timing check and a crosstalk analysis for physical implementation. Checking whether interconnections and wirings of transistors match a predetermined circuit and checking whether wiring spaces and gate lengths comply with preset specifications. Producing a mask based on the virtual layer.

In embodiments, a method for changing physical layout data using a virtual layer in standard logic cells may include at least one of the following steps: Determining whether N and P active layer names are present. If N and P active layer names are present, determining whether a top cell has a hierarchy. If the top cell has a hierarchy, creating a lower cell list. Generating an N active virtual layer and a P active virtual layer in a lower cell. Deleting an existing common active layer from the lower cell. Determining whether a current cell is a last in the lower cell list. If the current cell is the last in the lower cell list, generating an N active virtual layer and a P active virtual layer in the top cell. Deleting an existing common active layer from the top cell.

In embodiments, a method for changing physical layout data using a virtual layer in I/O pad cells may include at least one of the following steps: Determining whether N and P active layer names are present. If N and P active layer names are present, determining whether a top cell has a hierarchy. If the top cell has a hierarchy, temporarily flattening lower cells of the top cell. Generating an N active virtual layer and a P active virtual layer in the flattened top cell. Deleting an existing common active layer from the flattened top cell and generating a new instance cell. Canceling the temporary flattening of the top cell. Instantiating the instance cell in the top cell.

### DRAWINGS

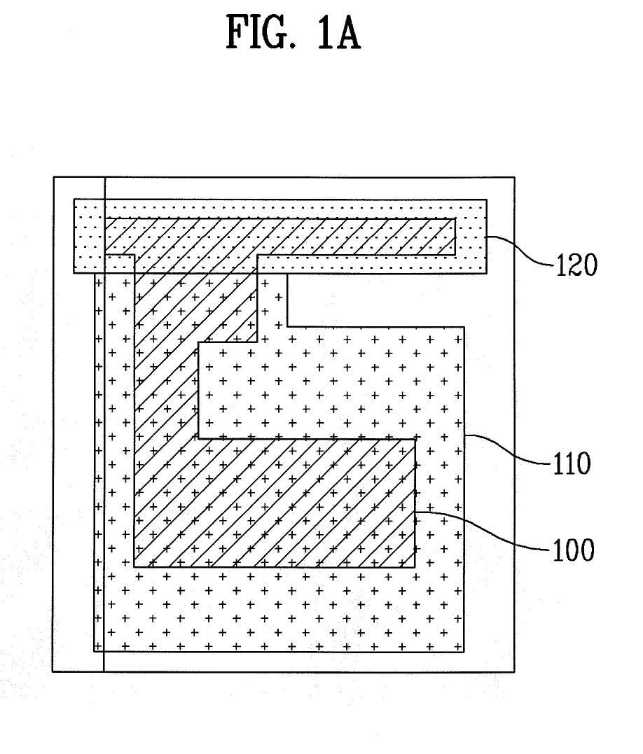

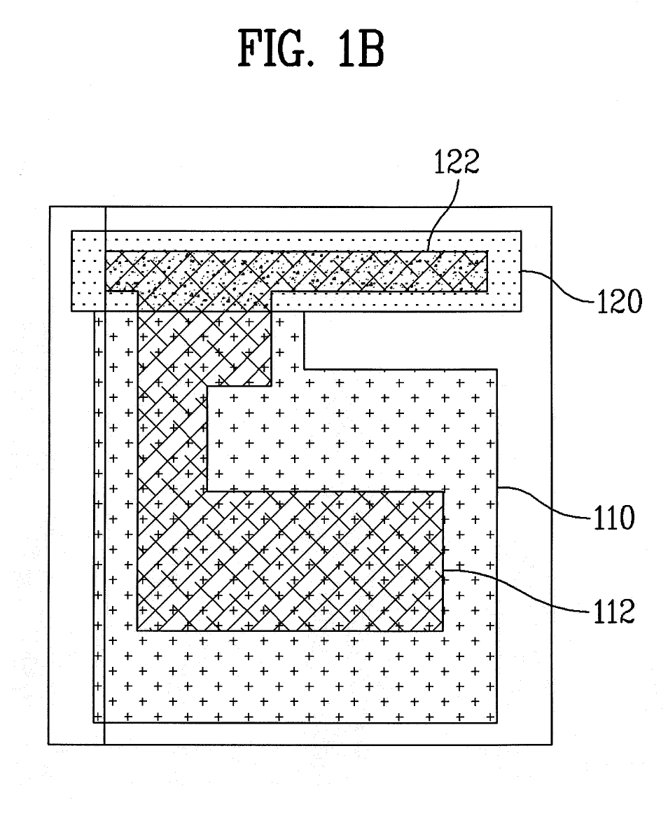

Example FIGS. 1A and 1B illustrate an original layout before it is changed using a Cadence SKILL program according to embodiments and a layout after it is changed using the Cadence SKILL program, respectively.

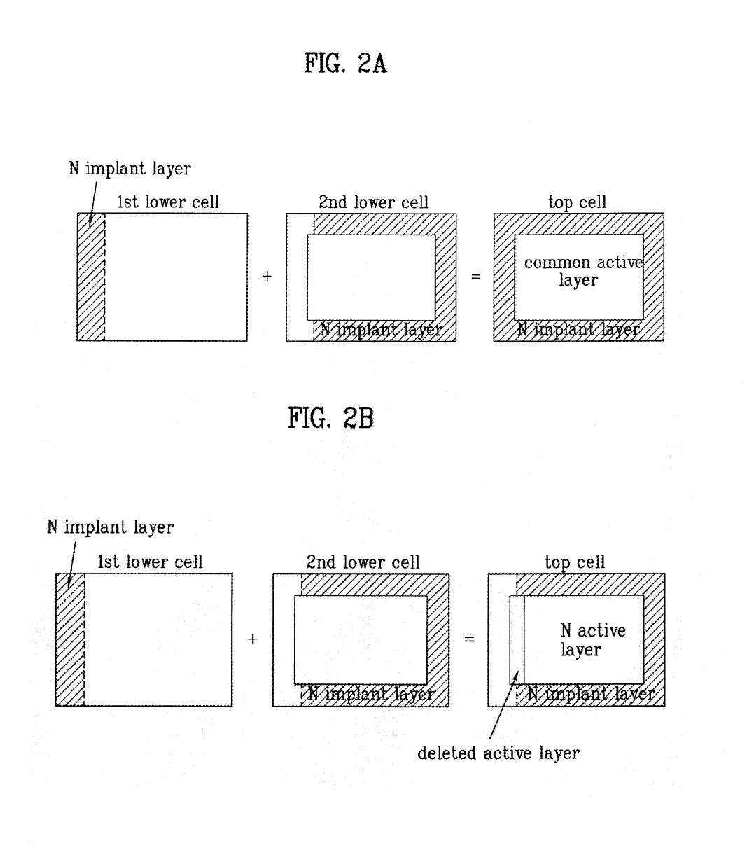

Example FIGS. 2A and 2B illustrate problems that may occur when an algorithm for standard logic is applied to I/O pad cells.

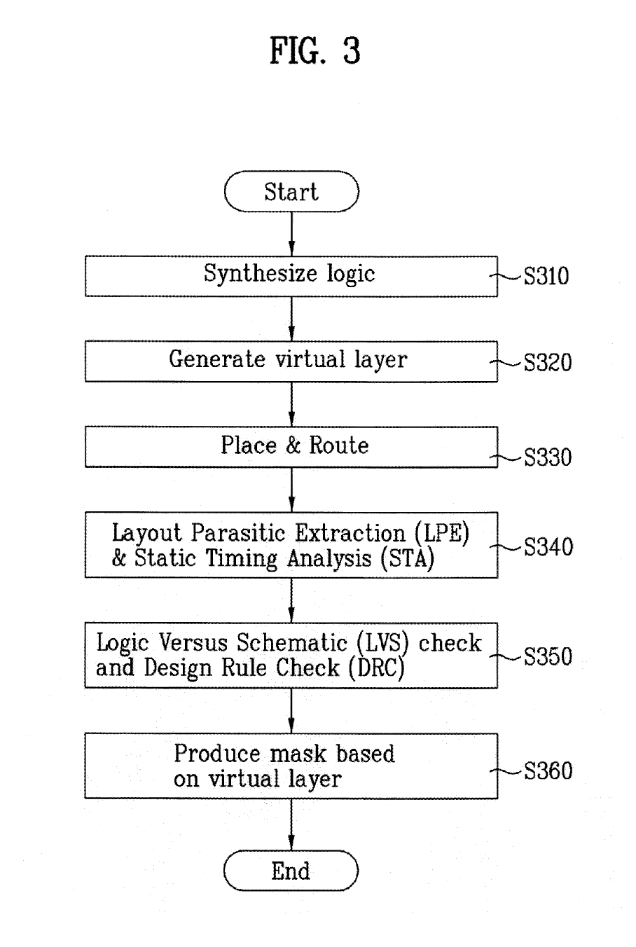

Example FIG. 3 is a flow chart illustrating a procedure for changing physical layout data using a virtual layer, according to embodiments.

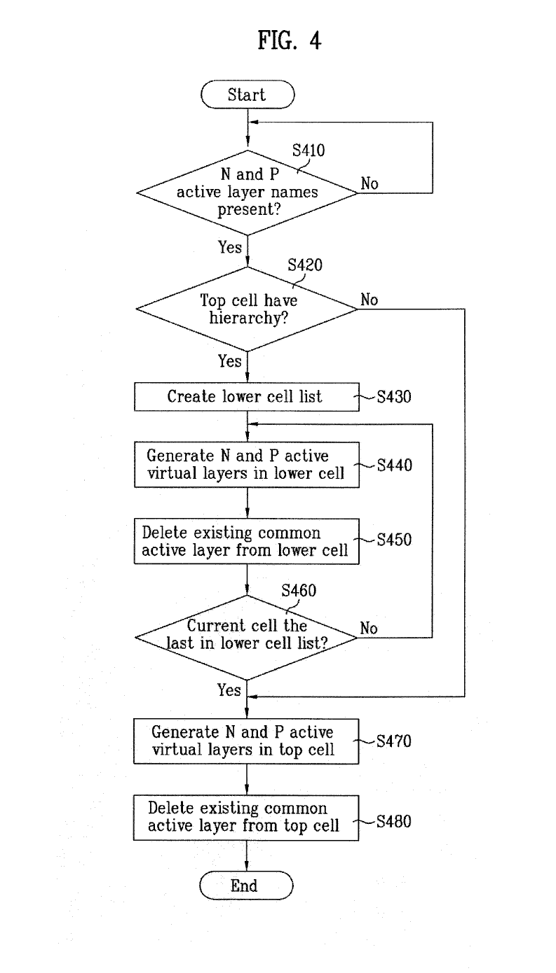

Example FIG. 4 is a flow chart illustrating a method for changing physical layout data using a virtual layer in standard logic cells, according to embodiments.

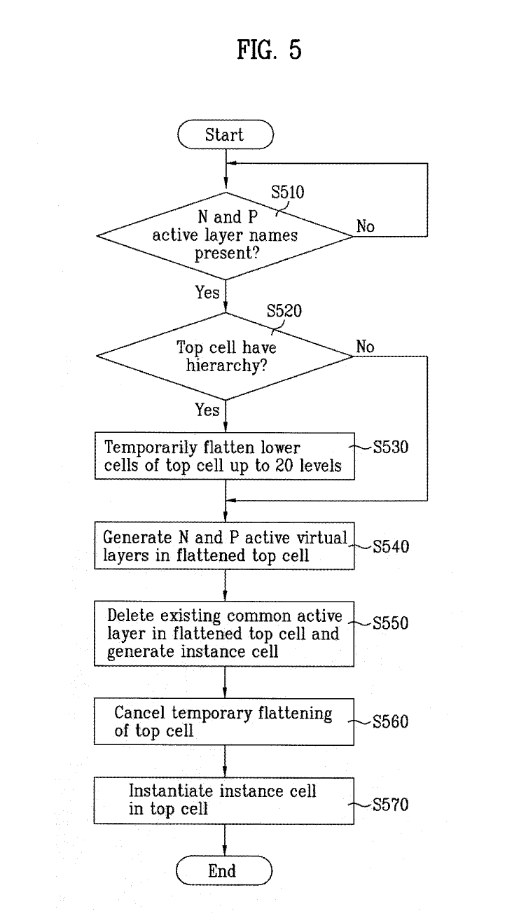

Example FIG. 5 is a flow chart illustrating a method for changing physical layout data using a virtual layer in I/O pad cells, according to embodiments.

### DESCRIPTION

Example Table 1 shows part of a Cadence SKILL program for standard logic to implement a virtual layer according to embodiments.

```
TABLE 1
(defun pghCreateActLayersCell (lib cell oldActLayer nimpLayer pimpLayer newNactLayer
newPactLayer)
  (letStar ((cv (dbOpenCellViewByType lib cell “layout” “maskLayout” “a”))
          (shapeList cv~>shapes)
        ;Check existence of layer name
;  (if !(existLayer? oldActLayer cv) then
;  (pghDialogBox “Active layer name does not exist, Please check again!”)
;  else (if !(existLayer? newNactLayer cv) then
;  (pghDialogBox “N+ Active layer name does not exist, Please check
again!”)
;  else (if !(existLayer? newPactLayer cv) then
;  (pghDialogBox “P+ Active layer name does not exist, Please
check again!”)
;  )
;  )
;  )
        ; Create new n-active Layer
        (if (cv~>shapes != nil) then
```

The Cadence SKILL program may be implemented in two types, one for standard logic and the other for Input/Output (I/O) pads. Example processing methods will be described in detail with reference to FIG. 3.

As shown in example FIGS. 1A and 1B, the original layout includes a common active layer 100, a P implant layer 110, and an N implant layer 120. The Cadence SKILL program, or other high-level interactive programming language, may be used to AND the common active layer 100 and the P implant layer 110 to generate a P active layer 112 shown in example FIG. IB. The Cadence SKILL program, or other high-level interactive programming language, may also be used to AND the common active layer 100 and the N implant layer 120 to generate an N active layer 122 shown in example FIG. 1B. Common active layer 100 is then deleted.

This algorithm may be appropriate for standard logic cells since their hierarchy is simple and their common active layers are present in one level. When this algorithm is performed for I/O pad cells, a number of Design Rule Check (DRC) errors may occur in active layers since their hierarchy is more complex than that of the standard logic cells. A common active layer, an N implant layer, and a P implant layer may be drawn in different levels. Details of these problems will be described below with reference to example FIGS. 2A and 2B.

Accordingly, another algorithm, different from that for standard logic cells, is used for I/O pad cells.

Example FIG. 2A shows an original layout of I/O pad cells. As shown in FIG. 2A, a top cell includes a first lower cell with an N implant layer in an area of the first lower cell and a second lower cell with an N implant layer and a common active layer in an area of the second lower cell. Thus, the top cell includes the common active and N implant layers which cover its entire area.

Example FIG. 2B shows a layout of I/O pad cells that is changed when the standard logic algorithm is applied to the I/O pad cells. Since the common active layer is present only in the second lower cell and the N implant layer does not sufficiently surround the common active layer, part of the N active layer is deleted from the top cell, thus causing a DRC error such that the I/O pad cell layout is changed.

To overcome this problem, the algorithm for I/O pad cells may temporarily flatten the entire layout, and generate an N active layer and a P active layer. The algorithm deletes a common active layer, thereby generating an instance cell. The algorithm then exits the temporarily flattened layout without storing it and then calls the instance cell as an instance in the top cell. Here, the term “instance” refers to an abstract concept or a real implementation of a template such as a class object or a computer process and the term “instantiation” refers to the generation of an instance through processes of defining a specific modification of an object in a class, naming the specific modification, and locating it at a specific physical location.

It takes a little longer to execute the program for I/O pad cells than to execute the algorithm for standard logics since the flattening process is performed. However, when the program for I/O pad cells is executed, the cell size is almost the same as the original size since the cell hierarchy is not usually altered by generating a new cell.

As shown in example FIG. 3, a target design may be coded and a logic for the coded target design may be synthesized (S310). Then, a virtual layer may be generated using a Cadence SKILL program (S320) or other high-level interactive programming language. The method for generating a virtual layer may be classified into two types, one for standard logics and the other for I/O pad cells, which will be described in detail later with reference to example FIGS. 4 and 5.

A Place & Route process may be performed to place logic blocks at corresponding positions and to route them for connection to execution elements (S330).

Layout Parasitic Extraction (LPE) may be performed to extract accurate wiring resistance or capacitance values from a layout for which the place & route process for the logic synthesis has been completed. A timing check and a crosstalk analysis may be performed through a Static Timing Analysis (STA) for physical implementation (S340).

A Logic Versus Schematic (LVS) check may be performed to check whether or not interconnections and wirings of transistors match the circuit. A Design Rule Check (DRC) may be performed to check whether the wiring spaces and gate lengths comply with preset specifications (S350). The same physical verification (LVS/DRC) may be performed for different fabs (i.e., fabs for standard logic cells and I/O pad cells) since the virtual layer is generated at step S320. Different LVS/DRC may otherwise be performed for different fabs. A mask may be produced using an Optical Proximity Correction (OPC) based on the virtual layer generated at step S320 (S360).

As shown in example FIG. 4, a determination is made whether N and P active layer names are present (S410). If N and P active layer names are present, then a determination is made whether a top cell has a hierarchy (S420). If the top cell has a hierarchy, then a lower cell list is created (S430).

If the top cell has no hierarchy, an N active virtual layer and a P active virtual layer are generated in the top cell and an existing common active layer is deleted from the top cell. After the lower cell list is created at step S430, an N active virtual layer and a P active virtual layer are generated in a lower cell (S440) and an existing common active layer is deleted from the lower cell (S450).

A determination is made whether the current cell is the last in the lower cell list (S460). If the current cell is the last in the lower cell list, then an N active virtual layer and a P active virtual layer are generated in the top cell (S470). The existing common active layer may be deleted from the top cell (S480). The method returns to step S440 to repeat the above procedure if the current cell is not the last.

As shown in example FIG. 5, a determination is made whether N and P active layer names are present (S510). If N and P active layer names are present, a determination is made whether a top cell has a hierarchy (S520). If the top cell has a hierarchy, then lower cells of the top cell may be temporarily flattened up to 20 levels (S530). Although the levels to be flattened in the hierarchy of the top cell are specified as the 20 levels in embodiments, the levels to be flattened may be changed freely as needed, without being limited to the 20 levels.

If the top cell has no hierarchy, the method proceeds to step S540. A new N active virtual layer and a new P active virtual layer may be generated in the flattened top cell (S540). An existing common active layer is deleted from the flattened top cell and a new instance cell is generated (S550).

The temporary flattening of the top cell is canceled (S560) and the instance cell is instantiated in the top cell (S570). Here, the term “instance” refers to an abstract concept or a real implementation of a template such as a class object or a computer process. The term “instantiation” refers to the generation of an instance through processes of defining a specific modification of an object in a class, naming the specific modification, and locating it at a specific physical location.

As is apparent from the above description, embodiments relate to a method for changing physical layout data using a virtual layer, wherein a virtual layer is generated by software prior to physical verification when physical layout data is changed. This makes it possible to use a Logic Versus Schematic/Design Rule Check (LVS/DRC) suitable for a fab in which actual processes are to be carried out, thereby achieving reliable physical verification. This increases the reliability of physical verification results, thereby maximizing the satisfaction of customers and significantly contributing to an increase in the throughput of products.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A method comprising:
coding a target design and synthesizing a logic for the coded target design;
generating a virtual layer;
placing logic blocks at positions and routing the logic blocks for connection to execution elements;
extracting at least one of wiring resistance values or capacitance values and performing a timing check and a crosstalk analysis for physical implementation;
checking whether interconnections and wirings of transistors match a circuit and checking whether wiring spaces and gate lengths comply with preset specifications; and
producing a mask based on the virtual layer.

2. The method of claim 1, wherein Layout Parasitic Extraction is performed to extract said at least one of wiring resistance values or capacitance values.

3. The method of claim 1, wherein a Static Timing Analysis is used for a physical implementation.

4. The method of claim 1, wherein a Logic Versus Schematic check is performed to check whether the interconnections and wirings of the transistors match the circuit.

5. The method of claim 1, wherein a Design Rule Check is performed to check whether a wiring space and a gate length comply with preset specifications.

6. The method of claim 1, wherein an Optical Proximity Correction is used to produce the mask based on the virtual layer.

7. The method of claim 1, wherein said generating a virtual layer comprises generating the virtual layer using a high-level interactive programming language.

8. A method comprising:
determining whether N and P active layer names are present;
if N and P active layer names are present, determining whether a top cell has a hierarchy;
if the top cell has a hierarchy, creating a lower cell list;
generating an N active virtual layer and a P active virtual layer in a lower cell;
deleting an existing common active layer from the lower cell;
determining whether a current cell is a last in the lower cell list;
if the current cell is the last in the lower cell list, generating an N active virtual layer and a P active virtual layer in the top cell; and
deleting an existing common active layer from the top cell.

9. The method of claim 8, comprising generating an N active virtual layer and a P active virtual layer in the top cell and deleting the existing common active layer from the top cell if the top cell has no hierarchy.

10. A method comprising:
determining whether N and P active layer names are present;
if N and P active layer names are present, determining whether a top cell has a hierarchy;
if the top cell has a hierarchy, temporarily flattening lower cells of the top cell;
generating an N active virtual layer and a P active virtual layer in the flattened top cell;
deleting an existing common active layer from the flattened top cell and generating a new instance cell;
canceling the temporary flattening of the top cell; and
instantiating the instance cell in the top cell.

11. The method according to claim 10, wherein the step c) includes temporarily flattening the lower cells of the top cell up to 20 levels if the top cell has a hierarchy.
